(19) United States
(12) Patent Application Publication
(10) Pub. No.: US 2026/0042254 A1
(43) Pub. Date: Feb. 12, 2026

(54) CUBOIDAL SPHERICAL PLATE LATTICE MATERIALS

(71) Applicant: Khalifa University of Science and Technology, Abu Dhabi (AE)

(72) Inventors: Abdulla Mohamed Ali Alhembar Almesmari, Abu Dhabi (AE); Imad Barsoum, Abu Dhabi (AE); Rashid Kamel Abu Al-Rub, Abu Dhabi (AE)

(21) Appl. No.: 18/800,626

(22) Filed: Aug. 12, 2024

(51) Int. Cl. B29C 64/188; B33Y 10/00; B33Y 80/00

(52) U.S. Cl. CPC B29C 64/188; B33Y 10/00; B33Y 80/00; B29C 2793/0027; B29C 2793/009

(57) ABSTRACT

A lattice material can include a set of unit cells. Each unit cell of the set of unit cells can have a cubic topological constraint, and each unit cell of the plurality of unit cells can include a set of spherical plates arranged in the unit cell. Each spherical plate of the set of spherical plates can intersect with another spherical plate of the set of spherical plates, and one or more spherical plates can be truncated to fit within the cubic topological constraint. Each spherical plate of the set of spherical plates can be formed according to a reference spherical plate having a diameter D and a thickness t.

### BACKGROUND OF THE INVENTION

Lattice materials have become increasingly popular due to recent improvements in additive manufacturing technology, as the lattice materials can provide a balance of lightweight design and strong mechanical characteristics. For example, lattice materials can be used for aircraft structural features, tools, furniture, and any other product or material that can benefit from lightweight design and strong mechanical characteristics. The microstructural design of a lattice material has a considerable impact on the mechanical response on a macroscopic scale. Current designs for lattice materials involve beams and struts, which are not ideal geometries for applications requiring high load-bearing capacity and resistance to deformation.

### BRIEF SUMMARY OF THE INVENTION

A lattice material can have a cuboidal spherical pattern. The lattice material can include a set of unit cells, and each unit cell of the set of unit cells can have a cubic topological constraint and can include a set of spherical plates arranged in the unit cell. Each spherical plate of the set of spherical plates can intersect with another spherical plate of the set of spherical plates, and one or more spherical plates of the set of spherical plates can be truncated to fit within the cubic topological constraint. Each spherical plate of the set of spherical plates can be formed according to a reference spherical plate having a diameter D and a thickness t.

In some embodiments, the cubic topological constraint can have an edge length l, and a value of the diameter D is larger than a value of the edge length l.

In some embodiments, each unit cell of the set of unit cells can have a set of corners defined by the cubic topological constraint, and a subset of spherical plates of the set of spherical plates can intersect at a first corner of the set of corners.

In some embodiments, the subset of spherical plates can include at least one spherical plate for each dimension of the cubic topological constraint, and the subset of spherical plates can have a symmetry for each dimension of the cubic topological constraint.

In some embodiments, the symmetry for each dimension can involve, for each dimension and for each particular spherical plate of the at least one spherical plate, the particular spherical plate being parallel to other spherical plates of the at least one spherical plate.

In some embodiments, the subset of spherical plates of the set of spherical plates can include (i) a first set of spherical plates aligned along a first dimension of the cubic topological constraint, (ii) a second set of spherical plates aligned along a second dimension of the cubic topological constraint in which the second set of spherical plates can be different than the first set of spherical plates, and in which the second dimension can be different than the first dimension, and (iii) a third set of spherical plates aligned along a third dimension of the cubic topological constraint in which the third set of spherical plates can be different than the first set of spherical plates and the second set of spherical plates, and in which the third dimension can be different than the first dimension and the second dimension.

In some embodiments, the first dimension, the second dimension, and the third dimension can each be orthogonal to one another, and the first set of spherical plates can be orthogonal to the second set of spherical plates and the third set of spherical plates.

In some embodiments, the first set of spherical plates, the second set of spherical plates, and the third set of spherical plates can each include more than one spherical plate, and the first set of spherical plates, the second set of spherical plates, and the third set of spherical plates can have a same total number of spherical plates.

In some embodiments, (i) each spherical plate included in the first set of spherical plates can be parallel to every other spherical plate included in the first set of spherical plates, (ii) each spherical plate included in the second set of spherical plates can be parallel to every other spherical plate included in the second set of spherical plates, and (iii) each spherical plate included in the third set of spherical plates can be parallel to every other spherical plate included in the third set of spherical plates.

In some embodiments, the set of spherical plates can have one or more symmetries and a relative density, and the one or more symmetries and the relative density can correspond to an optimized load-bearing capacity of the lattice material and an optimized resistance to deformation of the lattice material.

A method can be used to form a lattice material having a cuboidal spherical plate lattice. The method can include, for each unit cell of a set of unit cells for the lattice material, forming a set of spherical plates in a particular arrangement involving each spherical plate of the set of spherical plates intersecting another spherical plate of the set of spherical plates. Each spherical plate of the set of spherical plates can be formed according to a reference spherical plate having a diameter D and a thickness t. The method can additionally include, for each unit cell of a set of unit cells for the lattice material, truncating one or more spherical plates of the set of spherical plates to fit the set of spherical plates within a cuboidal topological constraint of the unit cell.

A structural material can have a base material that can include a cuboidal spherical plate lattice material. The cuboidal spherical plate lattice material can include a set of unit cells, and each unit cell of the set of unit cells can have a cubic topological constraint. Each unit cell of the set of unit cells can include a set of spherical plates arranged in the unit cell in an arrangement in which each spherical plate of the set of spherical plates can intersect with another spherical plate of the set of spherical plates. Each spherical plate of the set of spherical plates can be formed according to a reference spherical plate having a diameter D and a thickness t. One or more spherical plates of the set of spherical plates can be truncated to fit within the cubic topological constraint, and the cubic topological constraint can have an edge length l that is different than the diameter D.

### BRIEF DESCRIPTION OF THE DRAWINGS

FIG. 1 is a diagram of a set of different cuboidal spherical plate lattice (CSPL) material structures according to some aspects of the present disclosure.

FIG. 2 is a perspective view of an example of a unit cell of a cuboidal spherical plate lattice (CSPL) according to some aspects of the present disclosure.

FIG. 3 is a diagram representing an optimization process for a cuboidal spherical plate lattice (CSPL) material according to some aspects of the present disclosure.

FIG. 4 is a diagram of varying relative densities for a cuboidal spherical plate lattice (CSPL) and topologically optimized cuboidal spherical plate lattice (TOCSPL) material according to some aspects of the present disclosure. The diagram also shows cross sections of the CSPL and TOCSPL lattices.

FIG. 5 is a flowchart of a process for forming a cuboidal spherical plate lattice (CSPL) material according to some aspects of the present disclosure.

FIG. 6 is a graph having a set of plots illustrating elastic properties for both cuboidal spherical plate lattice (CSPL) and topology optimized cuboidal spherical plate lattice (TOCSPL) materials according to some aspects of the present disclosure.

FIG. 7 is a graph having a plot of elastic properties for both cuboidal spherical plate lattice (CSPL) and topology optimized cuboidal spherical plate lattice (TOCSPL) materials, compared with other lattice materials according to some aspects of the present disclosure.

FIG. 8 is a graph having a plot of yield strength for both cuboidal spherical plate lattice (CSPL) and topology optimized cuboidal spherical plate lattice (TOCSPL) materials, compared with other lattice materials according to some aspects of the present disclosure.

FIG. 9 is a graph having a plot of specific energy absorption for both cuboidal spherical plate lattice (CSPL) and topology optimized cuboidal spherical plate lattice (TOCSPL) materials, compared with other lattice materials according to some aspects of the present disclosure.

### DETAILED DESCRIPTION OF THE INVENTION

Certain aspects and examples of the present disclosure relate to a lattice material formed from a set of unit cells that each include a set of spherical plates within a cuboidal topological constraint. The lattice material can be used in additive manufacturing, such as 3-D printing or 3-D manufacturing, to generate a base material for structural components for vehicles, for structural components for consumer products, and/or other applications. The set of unit cells may include a sufficient number of cells to form the base material. For example, the set of unit cells may include ten cells, 20 cells, 40 cells, 80 cells, 160 cells or any other suitable number of cells. The set of cells may be arranged in a particular arrangement to form the lattice material. For example, the set of cells may be arranged linearly, in an array, such as a 2-D array or a 3-D array, and/or other alignments. Each unit cell of the set of unit cells may be defined by the cuboidal topological constraint. In some examples, the cuboidal topological constraint may be an approximately cubical space in which the cell can be contained. The set of spherical plates for the cell may fit within the cuboidal spherical constraint and overlap one another to provide structural properties such as enhanced yield strength, elasticity, specific energy absorption, and/or other characteristics. In some examples, at least some spherical plates of the set of spherical plates may be truncated to fit within the cuboidal topological constraint.

To maximize the benefits of topology optimization for producing lattice materials with increased stiffness and strength, more efficient shapes than in existing trusses can be used. A lattice material with a plate-based structure can be used to maximize the benefits of topology optimization. The lattice material can be or include a cuboidal spherical plate lattice. Structures of the cuboidal spherical plate lattice can be based on plate-based lattices that can have superior stiffness and strength compared to other lattice designs. The cuboidal spherical plate lattice structures can be enhanced by using a constraint domain topology optimization method to further improve performance features. The constraint domain can preserve the base design of the cuboidal spherical plate lattice while enabling new topologically optimal features to develop under specific loading and boundary conditions. The structures of the cuboidal spherical plate lattice material can approach or arrive at the Hashin-Shtrikman (HS) upper bound, which represents the theoretical elastic limit for isotropic cellular material. Cuboidal spherical plate lattices, and topologically optimized cuboidal spherical plate lattices, can outperform several other lattice structures, such as honeycomb, triply periodic minimal surface, truss, and plate-based designs, in terms of uniaxial modulus, yield strength, energy absorption, and/or other characteristics.

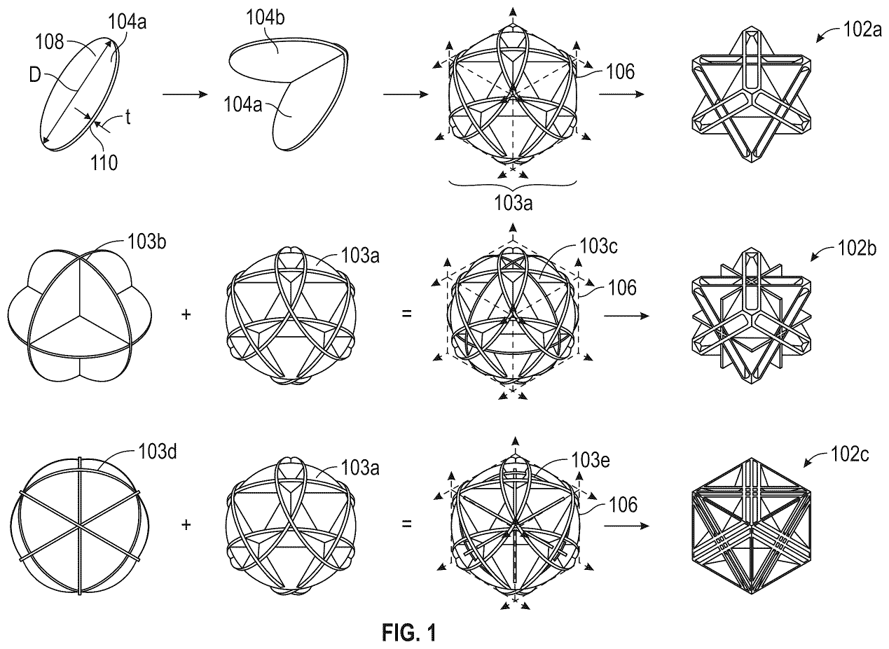

FIG. 1 is a diagram of a set of different cuboidal spherical lattice material structures according to some aspects of the present disclosure. In FIG. 1, and the description thereof, referring to a cuboidal spherical plate lattice, or to a spherical plate lattice, refers to a unit cell thereof unless otherwise specified. For example, a first cuboidal spherical plate lattice 102a, a second cuboidal spherical plate lattice 102b, and a third cuboidal spherical plate lattice 102c are illustrated in FIG. 1 via the respective unit cells.

As illustrated in FIG. 1, the diagram includes a first cuboidal spherical plate lattice 102a, a second cuboidal spherical plate lattice 102b, and a third cuboidal spherical plate lattice 102c, though other examples of structures of cuboidal spherical plate lattices are possible within the scope of the present disclosure. In some examples, the first cuboidal spherical plate lattice 102a may be a first cuboidal spherical plate lattice generated from a first spherical plate lattice 103a. For example, a set of spherical plates, which may include a first spherical plate 104a and a second spherical plate 104b, can be arranged together to form the first spherical plate lattice 103a. The first spherical plate lattice 103a may be mostly positioned within a cubic topological constraint 106, but at least a portion of some spherical plates of the set of spherical plates of the first spherical plate lattice 103a may extend beyond the cubic topological constraint 106. The cubic topological constraint 106 may have an edge length l that may be smaller than a diameter 108. For example, l may be from approximately 0.1 cm to approximately 1 cm, from approximately 1 cm to approximately 3 cm, from approximately 3 cm to approximately 6 cm, or other suitable measures. In some examples, the portion of some spherical plates that extend beyond the cubic topological constraint 106 may be truncated, or otherwise suitably removed, to cause each spherical plate of the set of spherical plates to fit within the cubic topological constraint 106 to form the first cuboidal spherical plate lattice 102a.

In some examples, each spherical plate of the set of spherical plates may be formed according to a representative spherical plate. As illustrated in FIG. 1, the representative spherical plate may be or include the first spherical plate 104a. The first spherical plate 104a has a diameter 108 and a thickness 110 in which the diameter 108 is approximately D, and the thickness 110 is approximately t. In some examples, D may be from approximately 0.1 cm to approximately 1 cm, from approximately 1 cm to approximately 3 cm, from approximately 3 cm to approximately 6 cm, or other suitable measures. Additionally or alternatively, t may be from approximately 0.1 mm to approximately 1 mm, from approximately 1 mm to approximately 3 mm, from approximately 3 mm to approximately 6 mm, or other suitable measures.

Being formed according to the representative spherical plate may mean that each spherical plate may be formed similarly, or approximately identical, to the representative spherical plate. For example, each spherical plate included in the set of spherical plates may have similar or approximately the same diameter, D, and thickness, t, as the representative spherical plate. Additionally or alternatively, each spherical plate of the set of spherical plates may be approximately shaped as a flattened sphere with a minimal thickness t in which, along the thickness t, the radius of the spherical plate is variable. In some examples, each spherical plate of the set of spherical plates may be approximately shaped as a flattened cylinder in which, along the thickness t, the radius of the spherical plate is constant.

In some examples, the set of spherical plates may be arranged overlapping one another to form the first spherical plate lattice 103a. For example, each spherical plate of the set of spherical plates may overlap with at least one other spherical plate of the set of spherical plates. Overlapping another spherical plate may involve the spherical plate contacting at least a portion of the another spherical plate of the set of spherical plates. Additionally or alternatively, each spherical plate of the set of spherical plates may intersect with another spherical plate of the set of spherical plates. The intersecting spherical plates may form the basis structure for the resulting cuboidal spherical plate lattice. Additionally or alternatively, each spherical plate of the set of spherical plates may intersect more than one other spherical plate of the set of spherical plates in which there is not a one-to-one correspondence with respect to spherical plates overlapping with one another. Stated differently, each spherical plate may intersect, and may be intersected by, more than one other spherical plate of the set of spherical plates.

The second cuboidal spherical plate lattice 102b may be formed from a combination of different spherical plate lattices. For example, and as illustrated in FIG. 1, the second cuboidal spherical plate lattice 102b may be a combination of the first spherical plate lattice 103a and a second spherical plate lattice 103b that is different from the first spherical plate lattice 103a. The second spherical plate lattice 103b may have a different number of spherical plates than the first spherical plate lattice 103a, may have a different arrangement of spherical plates than the first spherical plate lattice 103a, and/or may differ in other characteristics. Combining the first spherical plate lattice 103a and the second spherical plate lattice 103b can result in a third spherical plate lattice 103c that may have a combined set of spherical plates. In some examples, at least some spherical plates of the combined set of spherical plates may extend past the cubic topological constraint 106, and the spherical plates that do extend past the cubic topological constraint 106 may be truncated to cause each spherical plate included in the combined set of spherical plates to fit within the cubic topological constraint 106 to form the second cuboidal spherical plate lattice 102b. While the cubic topological constraint 106 is illustrated as being the same for the first cuboidal spherical plate lattice 102a and for the second cuboidal spherical plate lattice 102b, the cubic topological constraint 106 may differ for different cuboidal spherical plate lattices and may be selected to optimize one or more parameters for a base structure formed by the respective cuboidal spherical plate lattice.

The third cuboidal spherical plate lattice 102c may be formed from a combination of different spherical plate lattices. For example, and as illustrated in FIG. 1, the third cuboidal spherical plate lattice 102c may be a combination of the first spherical plate lattice 103a and a fourth spherical plate lattice 103d that is different from the first spherical plate lattice 103a, from the second spherical plate lattice 103b, and from the third spherical plate lattice 103c. The fourth spherical plate lattice 103d may have a different number of spherical plates than the other spherical plate lattices, may have a different arrangement of spherical plates than the other spherical plate lattices, and/or may have other differences. Combining the first spherical plate lattice 103a and the fourth spherical plate lattice 103d can result in a fifth spherical plate lattice 103e that may have a second combined set of spherical plates. In some examples, at least some spherical plates of the second combined set of spherical plates may extend past the cubic topological constraint 106, and the spherical plates that do extend past the cubic topological constraint 106 may be truncated to cause each spherical plate included in the second combined set of spherical plates to fit within the cubic topological constraint 106 to form the third cuboidal spherical plate lattice 102c. While the cubic topological constraint 106 is illustrated as being the same for the first cuboidal spherical plate lattice 102a, for the second cuboidal spherical plate lattice 102b, and for the third cuboidal spherical plate lattice 102c, the cubic topological constraint 106 may differ for different cuboidal spherical plate lattices and may be selected to optimize one or more parameters for a base structure formed by the respective cuboidal spherical plate lattice.

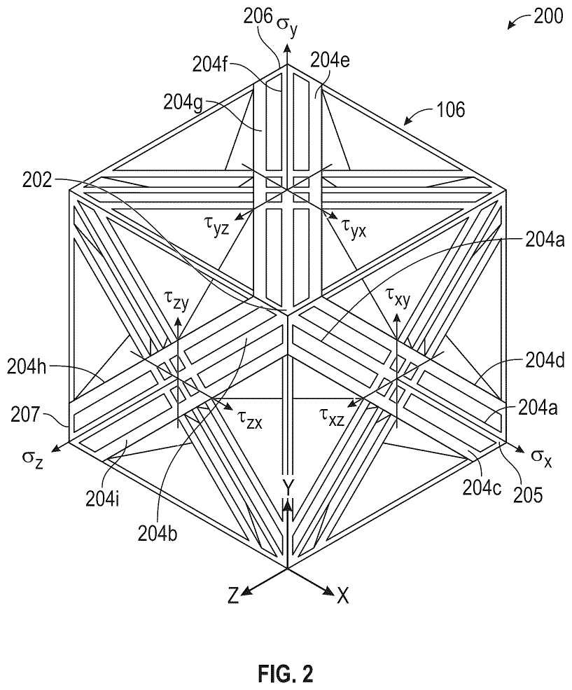

FIG. 2 is a perspective view of an example of a unit cell 200 of a cuboidal spherical plate lattice according to some aspects of the present disclosure. As illustrated, the unit cell 200 is similar or identical to the unit cell for the third cuboidal spherical plate lattice 102c as illustrated and described with respect to FIG. 1. It will be appreciated by one of ordinary skill in the art that the unit cell 200, and the below description thereof, can apply to other unit cells for other cuboidal spherical plate lattices that may have different numbers of spherical plates, different arrangements of spherical plates, and/or other differences.

As illustrated in FIG. 2, the unit cell 200 can be approximately cubic in shape. For example, the unit cell 200 may be sized, shaped, and/or otherwise arranged to fit within the cubic topological constraint 106, though other suitable sizes or shapes are possible for the unit cell 200. The unit cell 200 can include a set of corners such as corner 202. The set of corners may be defined by, or otherwise shared with, the cubic topological constraint 106. At each corner of the set of corners, a set of spherical plates may intersect one another. For example, at the corner 202, a first spherical plate 204a and a second spherical plate 204b may intersect or otherwise overlap one another. The first spherical plate 204a may be included in a subset of spherical plates that includes the first spherical plate 204a, a third spherical plate 204c, and a fourth spherical plate 204d, though the subset of spherical plates may include other suitable numbers (e.g., less than three or more than three) of spherical plates. The first spherical plate 204a, the third spherical plate 204c, and the fourth spherical plate 204d may be parallel to one another. The first spherical plate 204a, the third spherical plate 204c, and the fourth spherical plate 204d may extend to the corner 202 from the corner 205.

In some examples, the unit cell 200 may include at least one spherical plate for each dimension corresponding to the cubic topological constraint 106. A dimension of the cubic topological constraint 106 may include a spatial dimension such as an X, Y, or Z dimension as illustrated in FIG. 2, or any other suitable 3-D coordinate system. In some examples, a dimension of the cubic topological constraint 106 may include an edge or a side of the cubic topological constraint 106. Additionally or alternatively, the spherical plates included in the unit cell 200 may have a symmetry for each dimension of the cubic topological constraint 106. In some examples, the symmetry can include at least one spherical plate being parallel to at least one other spherical plate included in the unit cell 200.

In a particular example, the unit cell 200 can include a subset of spherical plates that can include a fifth spherical plate 204e, a sixth spherical plate 204f, and a seventh spherical plate 204g that can extend from corner 206 to the corner 202. The fifth spherical plate 204e, the sixth spherical plate 204f, and the seventh spherical plate 204g can be aligned along a first dimension of the cubic topological constraint 106. The corner 202 can also include a third set of spherical plates that includes the second spherical plate 204b, an eighth spherical plate 204h, and a ninth spherical plate 204i. The third set of spherical plates can extend from the corner 207 to the corner 202, may intersect with the other spherical plates that extend to the corner 202, and can be aligned with a second dimension of the cubic topological constraint 106. The first spherical plate 204a, the third spherical plate 204c, and the fourth spherical plate 204d can be aligned along a third dimension of the cubic topological constraint 106 (e.g., extending between the corner 205 and the corner 202). The corners 205, 206, and 207 may each be opposite the corner 202 along different faces of the cubic topological constraint 106, such as along diagonals on the faces.

In some examples, the first spherical plate 204a, the third spherical plate 204c, and the fourth spherical plate 204d may form a first set of spherical plates, the fifth spherical plate 204e, the sixth spherical plate 204f, and the seventh spherical plate 204g may form a second set of spherical plates, and the second spherical plate 204b, the eighth spherical plate 204h, and the ninth spherical plate 204i may form a third set of spherical plates. The second set of spherical plates and the third set of spherical plates may be different from the first set of spherical plates, and the first dimension may be different than, such as orthogonal with respect to, the second dimension and/or the third dimension. For example, each spherical plate included in the second set of spherical plates and each spherical plate included in the third set of spherical plates may be orthogonal with respect to each spherical plate included in the first set of spherical plates. As illustrated in FIG. 2, the first set of spherical plates, the second set of spherical plates, and the third set of spherical plates each includes more than one spherical plate and includes a common number of spherical plates. While the common number is illustrated as three spherical plates, any other suitable number (e.g., two or more than three) of spherical plates is possible.

In some examples, each spherical plate included in the unit cell 200 may be parallel to other spherical plates included in a common set. As illustrated, the fifth spherical plate 204e, the sixth spherical plate 204f, and the seventh spherical plate 204g may be parallel to one another. Additionally or alternatively, the spherical plates included in the first set of spherical plates may be parallel to one another, and the spherical plates included in the third set of spherical plates may be parallel to one another.

The spherical plates included in the unit cell 200 may be arranged to enhance or otherwise optimize a load-bearing capacity of lattice material including the unit cell 200, to enhance or otherwise optimize a resistance to deformation of the lattice material including the unit cell 200, and/or to enhance one or more relevant other characteristics. For example, the spherical plates included in the unit cell 200 may be arranged such that the normal stresses experienced by the unit cell 200 are approximately equal to one another. As illustrated in FIG. 2, the unit cell 200 can experience a first normal stress σₓ, a second normal stress σ_{y}, and a third normal stress σ_{z} in which, for the respective magnitudes, σₓ=σ_{y}=σ_{z}. Additionally or alternatively, the spherical plates included in the unit cell 200 may be arranged such that the shear stresses experienced by the unit cell 200 are approximately equal to one another in which, for the respective magnitudes, τ_{xy}=τ_{yx}=τ_{yz}=τ_{zy}=τ_{xz}=τ_{zx}. In some examples, a relative density of the spherical plates in the unit cell 200 may also be adjusted to optimize the load-bearing capacity of lattice material including the unit cell 200, to optimize the resistance to deformation of the lattice material including the unit cell 200, and/or to enhance one or more relevant other characteristics.

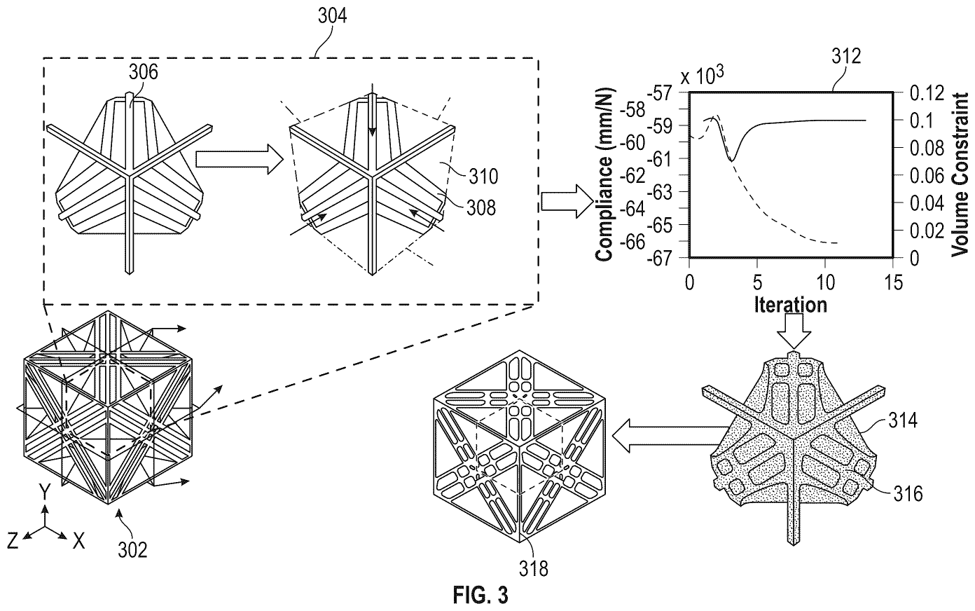

FIG. 3 is a diagram representing an optimization process for a cuboidal spherical lattice material according to some aspects of the present disclosure. In some examples, FIG. 3 may represent a constrained-domain topology optimization procedure for a particular cuboidal spherical plate lattice 302. The constrained-domain topology optimization procedure may begin at a first step 304 and after a base unit cell design for the particular cuboidal spherical plate lattice 302 is selected. In some examples, the first step 304 may involve analyzing at least a corner 306 of the particular cuboidal spherical plate lattice 302. The analysis may involve a Boolean operation or other suitable analysis that can involve determining loading conditions and boundary conditions. For example, the analysis may identify a frozen area 308 that is predetermined, and to remain unchanged, by the arrangement of spherical plates in the particular cuboidal spherical plate lattice 302. Additionally or alternatively, the analysis may identify a design region 310 that can be adjusted to optimize parameters of the particular cuboidal spherical plate lattice 302. In some examples, the parameters for adjustment can include a relative density. The analysis may be performed iteratively to produce a desired relative density and volume constraint, or to produce a relative density and volume constraint within a predetermined threshold of the desired relative density and volume constraint. A compliance plot 312 illustrates multiple iterations, shown on the horizontal axis, of analysis that resulted, for example on the 11^{th} iteration, in a converged compliance, shown on the left-hand vertical axis, and was within the volume constraint, shown on the right-hand vertical axis.

A raw output 314 of the iterative analysis may be used to adjust the particular cuboidal spherical plate lattice 302. The raw output 314 may be or include an optimized corner, which may be approximately ⅛, of the particular cuboidal spherical plate lattice 302. The raw output 314 may include a structure of the optimized corner and may have a relative density that corresponds to optimized load-bearing capacity and an optimized resistance to deformation for the base structure formed by the particular cuboidal spherical plate lattice 302. As illustrated in FIG. 3, the raw output 314 includes a relative density that is higher than that of the particular cuboidal spherical plate lattice 302. The relative density may be increased by adding feature 316 to the particular cuboidal spherical plate lattice 302. In some examples, the feature 316 may include an additional spherical plate, a beam between spherical plates, and/or one or more other geometric structures. The raw output 314 can be used to form an optimized particular cuboidal spherical plate lattice 318. For example, the raw output 314, or the structure thereof, can be applied to each corner of the particular cuboidal spherical plate lattice 302 to convert the particular cuboidal spherical plate lattice 302 to the optimized particular cuboidal spherical plate lattice 318.

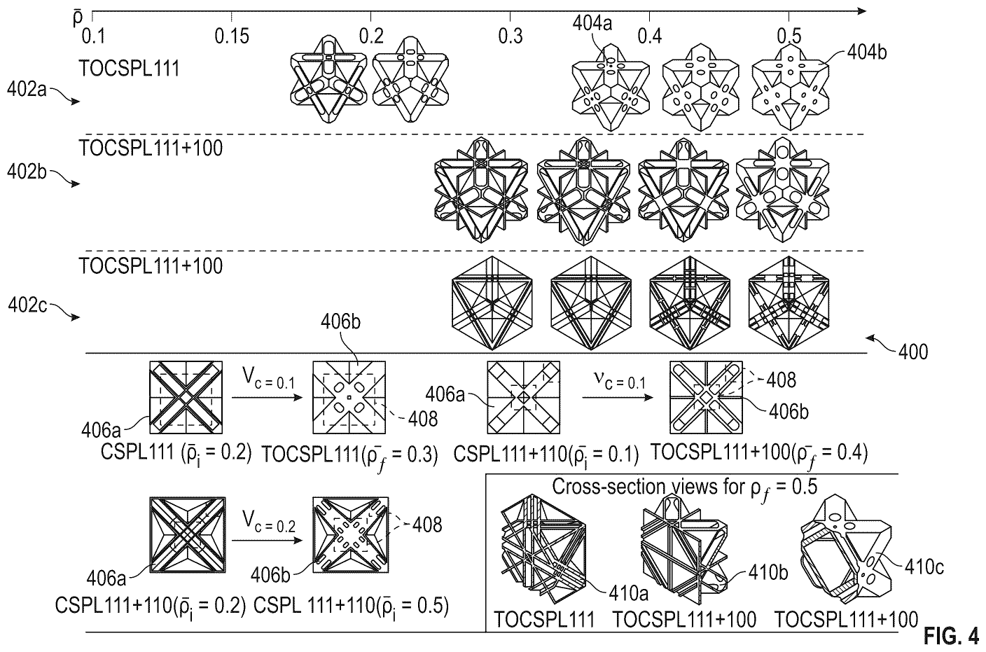

FIG. 4 is a diagram of varying relative densities for both cuboidal spherical plate lattice (CSPL) and topology optimized cuboidal spherical plate lattice (TOCSPL) materials according to some aspects of the present disclosure. As illustrated in FIG. 4, a chart 400 of different cuboidal spherical plate lattices is illustrated, and the chart 400 includes three rows that correspond to a first topology optimized cuboidal spherical plate lattice (TOCSPL) 402a, a second topology optimized cuboidal spherical plate lattice (TOCSPL) 402b, and a third topology optimized cuboidal spherical plate lattice (TOCSPL) 402c, respectively. A first row illustrates different structures corresponding to different relative densities for the first topology optimized cuboidal spherical plate lattice (TOCSPL) 402a, the second row illustrates different structures corresponding to different relative densities for the second topology optimized cuboidal spherical plate lattice (TOCSPL) 402b, and the third row illustrates different structures corresponding to different relative densities for the third topology optimized cuboidal spherical plate lattice (TOCSPL) 402c. For example, a representative unit cell for the respective topology optimized cuboidal spherical plate lattice (TOCSPL) is illustrated from left to right with increasing relative density. In a particular example, and as illustrated in FIG. 4, a first example 404a of the first topology optimized cuboidal spherical plate lattice (TOCSPL) 402a has a relative density of approximately 0.3, and a second example 404b of the first topology optimized cuboidal spherical plate lattice (TOCSPL) 402a has a relative density of approximately 0.5. In the first example 404a and the second example 404b, while the densities are different, the base structure, such as the arrangement of spherical plates, etc., are common among the first example 404a and the second example 404b.

As illustrated in FIG. 4, the relative density of a cuboidal spherical plate lattice can be increased by filling open holes. For example, a first stage 406a of a cuboidal spherical plate lattice can have a first relative density, and a second stage 406b of the topology optimized cuboidal spherical plate lattice (TOCSPL) can have a second relative density that is greater than the first relative density. The cuboidal spherical plate lattice is converted from the first stage 406a to the second stage 406b by filling some openings, such as opening 408, which is a consequence of the topology optimization procedure. Additionally as illustrated in FIG. 4, cross-sections of different cuboidal spherical plate lattice (CSPL) and topology optimized cuboidal spherical plate lattice (TOCSPL) materials are shown. A first cross-section 410a can correspond to the first topology optimized cuboidal spherical plate lattice (TOCSPL) 402a with a relative density of approximately 0.5, a second cross-section 410b can correspond to the second topology optimized cuboidal spherical plate lattice (TOCSPL) lattice 402b with a relative density of approximately 0.5, and a third cross-section 410c can correspond to the third topology optimized cuboidal spherical plate lattice (TOCSPL) lattice 402c with a relative density of approximately 0.5.

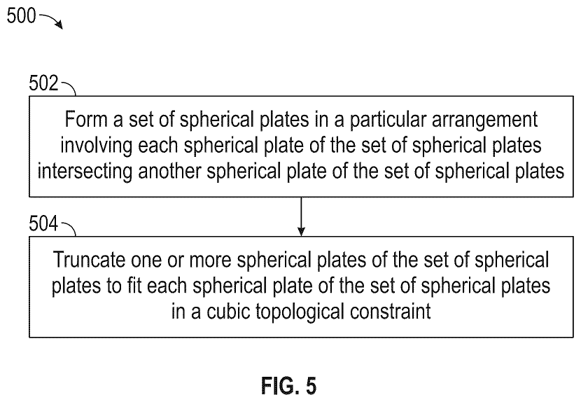

FIG. 5 is a flowchart of a process 500 for forming a cuboidal spherical lattice material according to some aspects of the present disclosure. In some examples, the process 500 may be an iterative process that can be performed for each unit cell of a set of unit cells, or any suitable subset thereof, of a lattice material. At block 502, a set of spherical plates are formed. In some examples, the set of spherical plates can be formed in a particular arrangement that can involve each spherical plate of the set of spherical plates intersecting another spherical plate of the set of spherical plates. Additionally or alternatively, each spherical plate of the set of spherical plates can be formed according to a reference spherical plate having a diameter D and a thickness t. In some examples, being formed according to the reference spherical plate may involve forming each spherical plate of the set of spherical plates, or any suitable subset thereof, to have the diameter D and the thickness t. Additionally or alternatively, at least some spherical plates of the set of spherical plates may have a diameter and a thickness that are not identical to, but may be similar to, the diameter D and the thickness t.

In some examples, forming the set of spherical plates can involve forming a set of corners defined by a cubic topological constraint, such as the cubic topological constraint 106. Additionally or alternatively, at least a subset of spherical plates of the set of spherical plates can intersect at a first corner of the set of corners. The subset of spherical plates can include at least one spherical plate for each dimension, such as a 3-D spatial dimension, of the cubic topological constraint. The subset of spherical plates can have a symmetry for each dimension of the cubic topological constraint. The symmetry may include a mirror image, may include spherical plates being parallel to one another, and/or other arrangements. In some examples, forming the set of spherical plates can include, for each dimension and for each particular spherical plate of the at least one spherical plate, forming the particular spherical plate parallel to other spherical plates of the at least one spherical plate.

In some examples, forming the set of spherical plates can include forming a first subset of spherical plates corresponding to a first dimension of the cubic topological constraint, forming a second subset of spherical plates corresponding to a second dimension of the cubic topological constraint, and forming a third subset of spherical plates corresponding to a third dimension of the cubic topological constraint. The first subset of spherical plates may be different from the second subset of spherical plates and the third subset of spherical plates. Additionally or alternatively, the first dimension may be different from the second dimension and the third dimension. The first dimension, the second dimension, and the third dimension may each be orthogonal to one another, and the first subset of spherical plates may be orthogonal to the second subset of spherical plates and the third subset of spherical plates. In some examples, forming the set of spherical plates may include forming the first subset of spherical plates, the second subset of spherical plates, and the third subset of spherical plates to each include more than one spherical plate and to include a same total number of spherical plates.

At block 504, one or more spherical plates of the set of spherical plates are truncated. Truncating the one or more spherical plates may involve removing at least a portion of the one or more spherical plates, may involve reducing a size, such as a diameter, of the one or more spherical plates, and/or one or more other reductions. In some examples, the one or more spherical plates can be truncated to cause each spherical plate of the set of spherical plates to fit within a cubic topological constraint such as the cubic topological constraint 106. Additionally or alternatively, a relative density and/or other suitable parameters of the cuboidal spherical plate lattice can be adjusted, such as by filling holes between spherical plates, by adding beams between spherical plates, etc., to optimize, such as maximize, a load-bearing capacity and a resistance to deformation for a base structure formed by the cuboidal spherical plate lattice.

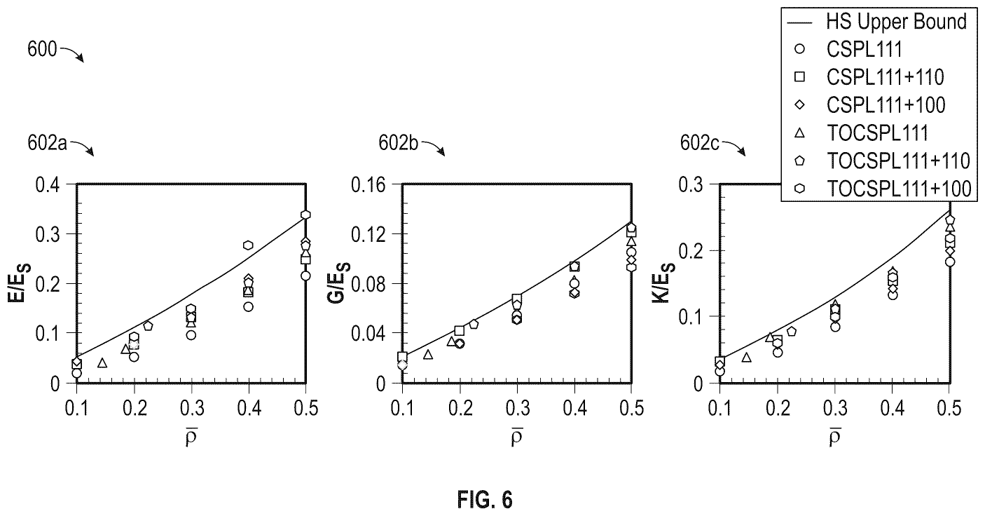

FIG. 6 is a graph 600 having a set of plots illustrating elastic properties for both cuboidal spherical plate lattice (CSPL) and topology optimized cuboidal spherical plate lattice (TOCSPL) materials according to some aspects of the present disclosure. The set of plots can include a first plot 602a, a second plot 602b, and a third plot 602c. Each plot included on the graph may be a normalized graph of elastic performances of various cuboidal spherical plate lattices (CSPL) and topology optimized cuboidal spherical plate lattices (TOCSPL) with respect to the HS upper bound.

The first plot 602a may be a plot of relative density on the horizontal axis versus uniaxial modulus on the vertical axis. The solid line on the first plot 602a represents the HS upper bound, and the points on the first plot 602a are shaped differently to represent the various different cuboidal spherical plate lattices and their topologically optimized counterparts (TOCSPL). As illustrated in the first plot 602a, the uniaxial modulus of each cuboidal spherical plate lattice and corresponding topologically optimized counterpart (TOCSPL) either approaches or arrives at the HS upper bound.

The second plot 602b may be a plot of relative density on the horizontal axis versus a shear modulus on the vertical axis. The solid line on the second plot 602b represents the HS upper bound, and the points on the second plot 602b are shaped differently to represent the various different cuboidal spherical plate lattices and their topologically optimized counterparts (TOCSPL). As illustrated in the second plot 602b, the shear modulus of each cuboidal spherical plate lattice and corresponding topologically optimized counterpart (TOCSPL) either approaches or arrives at the HS upper bound.

The third plot 602c may be a plot of relative density on the horizontal axis versus bulk modulus on the vertical axis. The solid line on the third plot 602c represents the HS upper bound, and the points on the third plot 602c are shaped differently to represent the various different cuboidal spherical plate lattices and their topologically optimized counterparts (TOCSPL). As illustrated in the third plot 602c, the bulk modulus of each cuboidal spherical plate lattice and corresponding topologically optimized counterpart (TOCSPL) either approaches or arrives at the HS upper bound.

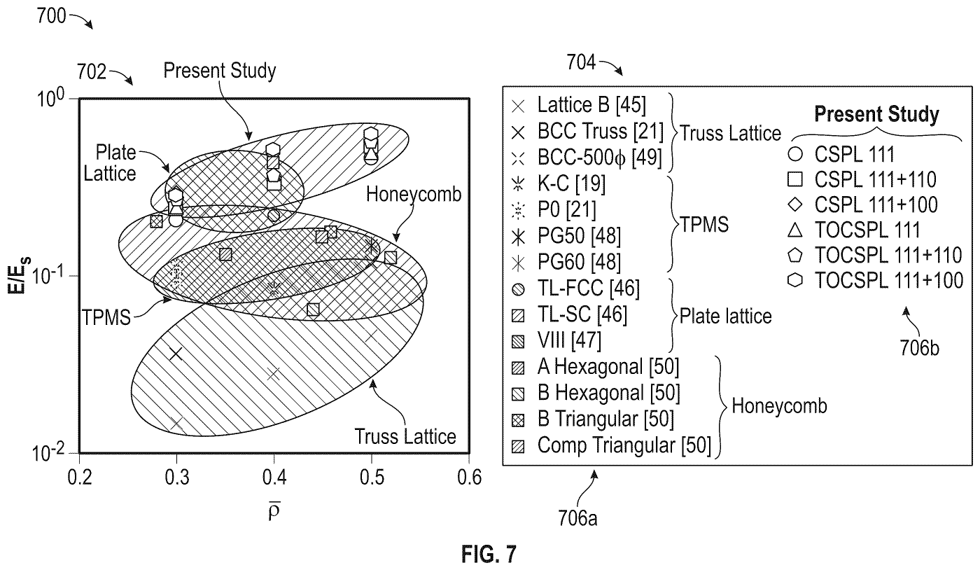

FIG. 7 is a graph 700 having a plot 702 of elastic properties for both cuboidal spherical plate lattice (CSPL) and topology optimized cuboidal spherical plate lattice (TOCSPL) materials, compared with other lattice materials according to some aspects of the present disclosure. The plot 702 may illustrate the normalized elastic modulus, on the vertical axis, of different lattices with respect to relative density, shown on the horizontal axis. The key 704 illustrates the different shapes of points on the plot 702. For example, the key 704 includes indications 706a of other lattices that are different from the cuboidal spherical plate lattices described herein, and the key 704 includes indications 706b of the cuboidal spherical plate lattices such as those described herein. As illustrated, in the graph 700, the plot 702 shows that the cuboidal spherical plate lattices (CSPL), such as those described herein, and topology optimized cuboidal spherical plate lattices (TOCSPL) have superior elastic moduli with respect to the other lattices.

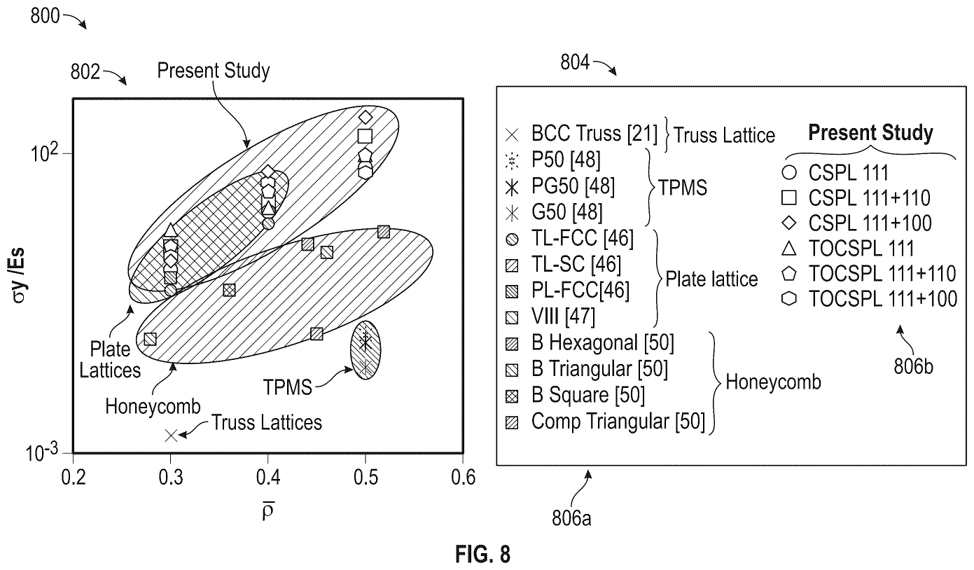

FIG. 8 is a graph 800 having a plot 802 of yield strength for both cuboidal spherical plate lattice (CSPL) and topology optimized cuboidal spherical plate lattice (TOCSPL) materials, compared with other lattice materials according to some aspects of the present disclosure. The plot 802 may illustrate the normalized yield strength, on the vertical axis, of different lattices with respect to relative density, shown on the horizontal axis. The key 804 illustrates the different shapes of points on the plot 802. For example, the key 804 includes indications 806a of other lattices that are different from the cuboidal spherical plate lattices described herein, and the key 804 includes indications 806b of the cuboidal spherical plate lattices such as those described herein. As illustrated, in the graph 800, the plot 802 shows that the cuboidal spherical plate lattices (CSPL), such as those described herein, and topology optimized cuboidal spherical plate lattices (TOCSPL) have superior yield strengths with respect to the other lattices.

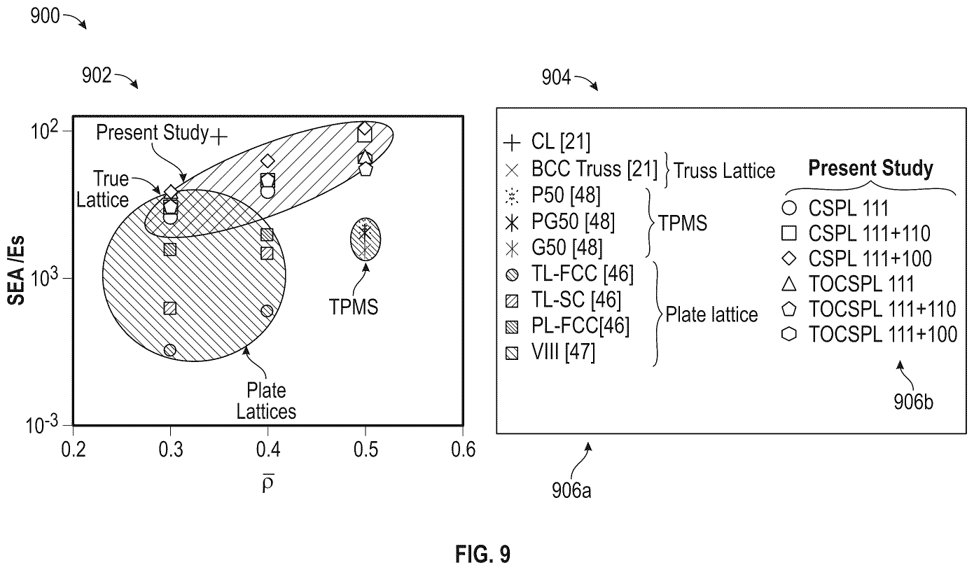

FIG. 9 is a graph 900 having a plot 902 of specific energy absorption for both cuboidal spherical plate lattice (CSPL) and topology optimized cuboidal spherical plate lattice (TOCSPL) materials, compared with other lattice materials according to some aspects of the present disclosure. The plot 902 may illustrate the normalized energy absorption, on the vertical axis, of different lattices with respect to relative density, shown on the horizontal axis. The key 904 illustrates the different shapes of points on the plot 902. For example, the key 904 includes indications 906a of other lattices that are different from the cuboidal spherical plate lattices described herein, and the key 904 includes indications 906b of the cuboidal spherical plate lattices such as those described herein. As illustrated, in the graph 900, the plot 902 shows that the cuboidal spherical plate lattices (CSPL), such as those described herein, and topology optimized cuboidal spherical plate lattices (TOCSPL) have superior energy absorption with respect to the other lattices.

The foregoing description of certain examples, including illustrated examples, has been presented only for the purpose of illustration and description and is not intended to be exhaustive or to limit the disclosure to the precise forms disclosed. Numerous modifications, adaptations, and uses thereof will be apparent to those skilled in the art without departing from the scope of the disclosure.

What is claimed is:

1. A lattice material comprising:
a plurality of unit cells, each unit cell of the plurality of unit cells having a cubic topological constraint, and each unit cell of the plurality of unit cells comprising:
a plurality of spherical plates arranged in the unit cell, wherein each spherical plate of the plurality of spherical plates intersects with another spherical plate of the plurality of spherical plates, wherein one or more spherical plates of the plurality of spherical plates are truncated to fit within the cubic topological constraint, and wherein each spherical plate of the plurality of spherical plates is formed according to a reference spherical plate having a diameter D and a thickness t.

2. The lattice material of claim 1, wherein the cubic topological constraint has an edge length l, and wherein a value of the diameter D is larger than a value of the edge length l.

3. The lattice material of claim 1, wherein each unit cell of the plurality of unit cells has a set of corners defined by the cubic topological constraint, and wherein a subset of spherical plates of the plurality of spherical plates intersect at a first corner of the set of corners.

4. The lattice material of claim 3, wherein the subset of spherical plates comprises at least one spherical plate for each dimension of the cubic topological constraint, and wherein the subset of spherical plates has a symmetry for each dimension of the cubic topological constraint.

5. The lattice material of claim 4, wherein the symmetry for each dimension involves, for each dimension and for each particular spherical plate of the at least one spherical plate, the particular spherical plate being parallel to other spherical plates of the at least one spherical plate.

6. The lattice material of claim 3, wherein the subset of spherical plates of the plurality of spherical plates comprises:
a first set of spherical plates aligned along a first dimension of the cubic topological constraint;
a second set of spherical plates aligned along a second dimension of the cubic topological constraint, wherein the second set of spherical plates is different than the first set of spherical plates, and wherein the second dimension is different than the first dimension; and
a third set of spherical plates aligned along a third dimension of the cubic topological constraint, wherein the third set of spherical plates is different than the first set of spherical plates and the second set of spherical plates, and wherein the third dimension is different than the first dimension and the second dimension.

7. The lattice material of claim 6, wherein the first dimension, the second dimension, and the third dimension are each orthogonal to one another, and wherein the first set of spherical plates are orthogonal to the second set of spherical plates and the third set of spherical plates.

8. The lattice material of claim 6, wherein the first set of spherical plates, the second set of spherical plates, and the third set of spherical plates each include more than one spherical plate, and wherein the first set of spherical plates, the second set of spherical plates, and the third set of spherical plates have a same total number of spherical plates.

9. The lattice material of claim 8, wherein:
each spherical plate included in the first set of spherical plates is parallel to every other spherical plate included in the first set of spherical plates;
each spherical plate included in the second set of spherical plates is parallel to every other spherical plate included in the second set of spherical plates; and
each spherical plate included in the third set of spherical plates is parallel to every other spherical plate included in the third set of spherical plates.

10. The lattice material of claim 1, wherein the plurality of spherical plates have one or more symmetries and a relative density, and wherein the one or more symmetries and the relative density correspond to an optimized load-bearing capacity of the lattice material and an optimized resistance to deformation of the lattice material.

11. A method for forming a lattice material comprising a cuboidal spherical plate lattice, the method comprising:
for each unit cell of a plurality of unit cells for the lattice material:
forming a plurality of spherical plates in a particular arrangement involving each spherical plate of the plurality of spherical plates intersecting another spherical plate of the plurality of spherical plates, wherein each spherical plate of the plurality of spherical plates is formed according to a reference spherical plate having a diameter D and a thickness t; and
truncating one or more spherical plates of the plurality of spherical plates to fit the plurality of spherical plates within a cuboidal topological constraint of the unit cell.

12. The method of claim 11, wherein forming the plurality of spherical plates comprises forming a set of corners defined by a cubic topological constraint, and wherein a subset of spherical plates of the plurality of spherical plates intersect at a first corner of the set of corners.

13. The method of claim 12, wherein the subset of spherical plates comprises at least one spherical plate for each dimension of the cubic topological constraint, wherein the subset of spherical plates has a symmetry for each dimension of the cubic topological constraint, and wherein forming the plurality of spherical plates comprises, for each dimension and for each particular spherical plate of the at least one spherical plate, forming the particular spherical plate parallel to other spherical plates of the at least one spherical plate.

14. The method of claim 12, wherein forming the plurality of spherical plates comprises forming:
a first set of spherical plates corresponding to a first dimension of the cubic topological constraint;
a second set of spherical plates corresponding to a second dimension of the cubic topological constraint, wherein the second set of spherical plates is different than the first set of spherical plates, and wherein the second dimension is different than the first dimension; and
a third set of spherical plates corresponding to a third dimension of the cubic topological constraint, wherein the third set of spherical plates is different than the first set of spherical plates and the second set of spherical plates, and wherein the third dimension is different than the first dimension and the second dimension.

15. The method of claim 14, wherein the first dimension, the second dimension, and the third dimension are each orthogonal to one another, and wherein the first set of spherical plates are orthogonal to the second set of spherical plates and the third set of spherical plates.

16. The method of claim 14, wherein forming the plurality of spherical plates comprises forming the first set of spherical plates, the second set of spherical plates, and the third set of spherical plates to each include more than one spherical plate and to include a same total number of spherical plates.

17. The method of claim 11, further comprising selecting one or more symmetries and a relative density for each spherical plate of the plurality of spherical plates, wherein the one or more symmetries and the relative density correspond to an optimized load-bearing capacity of the lattice material and an optimized resistance to deformation of the lattice material.

18. A structural material having a base material comprising a cuboidal spherical plate lattice material, the cuboidal spherical plate lattice material comprising:
a plurality of unit cells, each unit cell of the plurality of unit cells having a cubic topological constraint, and each unit cell of the plurality of unit cells comprising:
a plurality of spherical plates arranged in the unit cell in an arrangement in which each spherical plate of the plurality of spherical plates intersects with another spherical plate of the plurality of spherical plates, wherein each spherical plate of the plurality of spherical plates is formed according to a reference spherical plate having a diameter D and a thickness t, wherein one or more spherical plates of the plurality of spherical plates are truncated to fit within the cubic topological constraint, and wherein the cubic topological constraint has an edge length l that is different than the diameter D.

19. The structural material of claim 18, wherein the plurality of spherical plates have one or more symmetries and a relative density, and wherein the one or more symmetries and the relative density correspond to an optimized load-bearing capacity of the cuboidal spherical plate lattice material and an optimized resistance to deformation of the cuboidal spherical plate lattice material.

20. The structural material of claim 18, wherein each unit cell of the plurality of unit cells has a set of corners defined by the cubic topological constraint, wherein a subset of spherical plates of the plurality of spherical plates intersect at a first corner of the set of corners, wherein the subset of spherical plates comprises at least one spherical plate for each dimension of the cubic topological constraint, wherein the subset of spherical plates has symmetry for each dimension of the cubic topological constraint, wherein the symmetry for each dimension involves, for each dimension and for each particular spherical plate of the at least one spherical plate, the particular spherical plate being parallel to other spherical plates of the at least one spherical plate.
